(19) United States
(12) Patent Application Publication
(10) Pub. No.: US 2007/0129987 A1
(43) Pub. Date: Jun. 7, 2007

(54) ON-LINE BUSINESS-PACKET CREATOR FOR ELECTRONIC FORMS

(75) Inventors: Jamie Hauser, Blaine, MN (US); Christopher Lee Kemp, St. Paul, MN (US); Trica Ann Otto, Shoreview, MN (US); Munish Arora, Eden Prairie, MN (US); Ravi Kiran Gutta, Minnetonka, MN (US)

Correspondence Address: SNELL & WILMER L.L.P. (Main), 400 EAST VAN BUREN, ONE ARIZONA CENTER, PHOENIX, AZ, 85004-2202, US

(73) Assignee: AMERIPRISE FINANCIAL, INC., Minneapolis, MN (US)

(21) Appl. No.: 11/164,692

(22) Filed: Dec. 1, 2005

(51) Int. Cl. G06Q 99/00; G06F 15/02; G06F 9/46

(52) U.S. Cl. 705/9; 705/1

(57) ABSTRACT

A method for identifying forms required for a business transaction and providing a packet containing the required forms to a requestor is provided. The method includes storing a set of rules in a first memory region accessible by a server, and storing for each of a plurality of tasks at least one address corresponding to at least one form associated with the task in a second memory region accessible by the server. A computer displays a user interface that prompts the requestor to provide answers to a sequence of questions. The sequence of questions is determined according to the set of rules, and at least one subsequent question of the sequence of questions is based on an answer to a previous question of the sequence of questions. The server determines a task being handled by the requester, based on the answers to the sequence of questions, and identifies a set of forms necessary for the determined task based on information stored in the second memory region. The server obtains the identified set of forms and assembles the identified set of forms into a form packet, which is provided to the requestor via the computer.

### FIELD OF INVENTION

The present invention generally relates to a system and a method for identifying forms required for a business transaction and providing a packet containing the required forms to a requestor. More particularly, the present invention relates to a computer-based system and a computer-based method for interacting with a requestor to determine a business transaction to be performed by the requester, and providing the requestor with a packet containing forms that need to be completed as part of the business transaction.

### BACKGROUND OF INVENTION

Numerous types of business transactions are possible in today's business world. The business transactions may be simple or complex, and often require the gathering of information through the use of fillable business forms. Sometimes, the dissemination of information is required as well and often is accomplished through the use of informational business forms. The types of information to be gathered or to be disseminated depend on the type of business transaction involved.

Due to the large number of different types of business transactions that can take place, each having different information requirements, it often is difficult, confusing, and time consuming to determine how many and which business forms are necessary for a business transaction. Further, depending on the business transaction involved, government regulations may impose reporting requirements on the types of information to be notified or reported to regulatory agencies as well as the manner in which such information is to be reported. Additionally, government regulations may impose requirements on the types of information to be retained or stored and the manner in which such information is to be retained, depending on the business transaction involved. Furthermore, government regulations may impose disclosure requirements on some or all of the parties in a business transaction, depending on the type of business transaction involved.

For example, for a business transaction in which a financial planner is to purchase stock in Company A for a client by using the proceeds from the sale of stock in Company B, the financial planner needs to determine which forms if any are necessary for the stock purchase, the stock sale, government reporting requirements, etc. Further, if the client is an officer of Company B, different forms may be required than if the client is not a so-called “insider.” Furthermore, if the amount of stock to be purchased exceeds a pre-defined percentage of total shares of stock issued for Company A, other additional forms may be required. The financial planner therefore needs to keep track of a myriad of different forms requirements for the myriad of different types of business transactions in which he may be involved.

Forms often are updated to have new formats or to reflect new information requirements due to, for example, changes in government regulations and changes in company requirements. The updated forms usually render the older versions of the forms obsolete. However, because forms often are stockpiled in company supply rooms or in the desks of support staff (e.g., secretaries, clerks, assistants, or the like), there is a significant risk that the older versions of the forms do not get discarded when they become obsolete.

Accidental use of obsolete forms can lead to non-compliance with government regulations as well as delays in closing business transactions, especially when the current forms require additional information or additional signatures not required for the obsolete forms. Such delays can result in lost revenue, aborted business transactions, and unwanted attention from government regulators.

One conventional tactic that some businesses have used to deal with changes in forms requirements is to issue a bulletin to relevant personnel advising of the changes and the new forms that will be required for the affected business transactions. This tactic, however, does not ensure that the personnel will remember to use the new forms and, as discussed above, also does not ensure that stockpiled older versions of the forms will not be used.

Another conventional tactic is for a business to set up an instruction sheet for each business transaction in which the business may be involved. This tactic, however, requires that all business transactions be identified, and that instruction sheets be prepared and updated as needed for the identified business transactions. Clearly, the number and complexity of many of today's business transactions makes this tactic difficult to implement, especially for businesses such as financial institutions. Further, this tactic does not ensure that the correct instruction sheet will be selected and properly used for a business transaction, nor does it ensure that stockpiled obsolete forms will not be used. Additionally, when numerous forms are required for a business transaction, this tactic does not ensure that one or more of the required forms will not be inadvertently omitted.

Given the foregoing, what is needed is a system, a method, and a computer program product for automatically identifying all the forms required for a business transaction and providing the required forms in a packet to a requestor.

### SUMMARY OF INVENTION

The present invention meets the above-identified needs by providing a system, a method, and a computer program product for identifying forms required for a business transaction, obtaining the identified forms, and assembling the obtained forms into a packet. The packet is provided to a requester electronically after the requester provides sufficient information regarding the business transaction to enable the required forms to be identified. The forms in the packet may be prefilled with information, such as information regarding the requestor and information regarding a client of the requestor for whom the business transaction is to be performed, for example.

An advantage of the present invention is it automatically provides the requestor with the most up-to-date forms for the business transaction. This eliminates the need to rely on bulletins to know when a form has been modified.

Another advantage of the present invention is that it provides the requestor with all the necessary forms, thus avoiding the possibility that a necessary form is inadvertently omitted. This eliminates the need to provide instruction sheets itemizing the necessary forms for different business transactions.

The system includes a server interconnected with at least one computing system via a communication network. The server is equipped and programmed to present an interactive user interface to the computing system. The interactive user interface presents a user (e.g., a forms requestor) with screen pages of information and prompts the user to input responses to queries. In an embodiment of the present invention, a subsequent screen page presented to the user depends on the user's response to a query presented in a previous screen page.

The system also includes a user database, which stores information on users and the types of information accessible by each of the users; a client database, which stores information on clients of the users; and a transaction database, which stores user-client relationship information on the user or users corresponding to each client. In an embodiment of the present invention, the server accesses data from the client database and the transaction database through a hub or message-queue manager, which manages data requests from the server as well as data retrieved from the client database and the transaction database.

A forms database is accessible by the server. In one embodiment, the forms database stores a plurality of forms as separately addressable records, such that the server may identify a particular form for retrieval by using an address indicating where the form may be found. Forms stored in the forms database are updated as necessary, and any form no longer in use is deleted. This ensures that only current or up-to-date forms are retrieved for inclusion in forms packets. A content manager may be used to manage requests for forms received from the server.

When multiple (i.e., two or more) forms are necessary for a business transaction, the server uses a forms “stitching” application to stitch together or combine the multiple forms into a forms packet. The server then delivers the forms packet to the computing system.

The forms in the forms packet are electronic forms, and the user may fill out the forms by using the computing system to input information to be inserted at information fields in the forms. In one embodiment, the forms in the forms packet are pre-filled with information retrieved from the user database and the client database.

The system further includes a drafts database, which stores drafts of forms packets assembled for users. Partially completed forms of a forms packet may be stored in the drafts database for later completion. A forms packet saved in the drafts database is saved as information identifying the forms contained in the forms packet. Therefore, when a request is received to retrieve the forms packet from the drafts database, the forms belonging to the forms packet are retrieved anew from the forms database. This ensures that the most current versions of the forms are provided to the user, and prevents forms that have been updated in the interim, between formation of the forms packet and completion of the forms in the forms packet, from being overlooked. Any data saved for the forms packet is inserted at the appropriate information fields in the forms, including any updated forms, prior to presenting the forms packet (i.e., the draft) to the user.

Further features and advantages of the present invention as well as the structure and operation of various embodiments of the present invention are described in detail below with reference to the accompanying drawings.

### BRIEF DESCRIPTION OF THE DRAWINGS

The features and advantages of the present invention will become more apparent from the detailed description set forth below when considered in conjunction with the attached drawings, in which like reference numbers indicate identical or functionally similar elements. Additionally, the left-most digit of a reference number identifies the drawing in which the reference number first appears.

FIG. 1 schematically illustrates a system diagram of an exemplary forms-packet system, according to an embodiment of the present invention.

FIGS. 2A and 2B show a flowchart illustrating a forms-packet process, according to an embodiment of the present invention.

FIG. 3 shows a flowchart illustrating a retrieval process, according to an embodiment of the present invention.

FIG. 4 shows a block diagram of an exemplary computer system useful for implementing the present invention, according to an embodiment of the present invention.

### DETAILED DESCRIPTION

The present invention is directed to a system, a method, and a computer program product for identifying forms required for a business transaction, obtaining the identified forms, and assembling the obtained forms into a packet. The packet is provided to a requester electronically after the requester provides sufficient information regarding the business transaction to enable the required forms to be identified. The forms in the packet may be prefilled with information, such as information regarding the requester, information regarding a client of the requestor for whom the business transaction is to be performed, and/or the like, for example.

The requester may fill in the forms electronically, by inputting information through a computing system, for example, or the requestor may print hardcopies of the forms and fill them in manually. A partially completed draft may be saved electronically and retrieved at a later time for completion. Inputted information inserted at information fields in a form is formatted as XML (eXtensible Markup Language) data. The forms in the packet are saved as information identifying the forms. Therefore, should a form from the saved draft be updated before the draft has been completed, the updated form (and not the obsolete form) will be included with the draft when the draft is retrieved. Information inputted for the previous (now obsolete) form will be properly inserted at corresponding information fields in the updated form when the draft is retrieved, in accordance with known XML programming techniques.

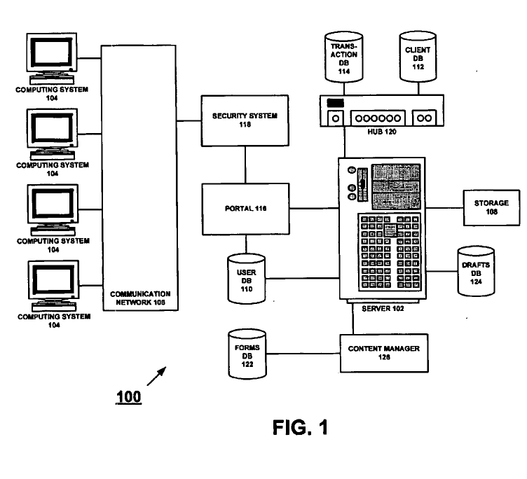

FIG. 1 shows a schematic system diagram of an exemplary forms-packet system 100 used to implement or practice one or more embodiments of the present invention. Forms-packet system 100 includes a server 102 interconnected with a computing system 104 via a communication network 106. A storage unit 108 is accessible by server 102 to store information therein or retrieve information therefrom. Storage unit 108 may be used to store software programs that are executed by server 102 to perform some or all of the functions described below, as well as to store information regarding business transactions, as discussed below. As will be appreciated by persons of skill in the relevant art(s), the functions described below may be implemented in hardware, software, or a combination thereof.

Communication network 106 may be an intranet, the Internet, a public switched telephone network (PSTN) with one or more dedicated leased lines, or any other means of communication between server 102 and computing system 104, whether wired or wireless. Computing system 104 may be any of a personal computer, a workstation, a mainframe computer, a personal digital assistant, or any other digital device able to perform data communication with server 102.

Server 102 is equipped and programmed to present an interactive user interface to computing system 104 via a portal 116. In another embodiment, the interactive user interface may be presented without a portal, directly via communications network 106 or through any other means known in the art. In one embodiment, the interactive user interface is a graphical user interface that visually presents a user (e.g., a requestor) with screen pages of information and prompts the user to input responses to queries. In one embodiment, a subsequent screen page presented to the user depends on the user's response to a query presented in a previous screen page. That is, server 102 runs a forms program, which determines the forms necessary for a task or business transaction to be handled by the user. The forms program may have a tree-type structure (“tree”), with branches of the tree representing different subroutines that, when executed, result in different screen pages presented to the user. Based on rules coded into the forms program, a response inputted for query on a screen page determines the next branch of the tree to be traversed (i.e., the next subroutine of the forms program to be executed) and thus the next screen page presented to the user, and so on. The branches of the tree traversed during execution of the program determine at least in part the forms that the user will need to complete for the business transaction.

Optionally, to ensure security, communications may occur with server 102 through a security system 118, which may be implemented with hardware, software, or a combination thereof. For example, security device 118 may include a firewall (e.g., a packet filter, an application gateway, a proxy server, a circuit-level gateway, or the like) and/or an authentication device, which verifies that a computing system attempting to communicate with server 102 and/or a user of the computing system attempting to communicate with server 102 are/is authorized to do so. The authentication device may be, for example, a security server equipped and programmed to perform a single sign-on (“SSO”) security procedure using stored identification data for authorized users. Other types of security measures may be employed, as will be appreciated by persons of skill in the relevant art(s).

Server 102 may include any hardware and/or software suitably configured to facilitate communications between the various system components as discussed herein. Further, server 102 may be configured to transmit data to and from computing system 104 within markup language documents. Server 102 may operate as a single entity in a single geographic location or as separate computing components located together or in separate geographic locations. Requests originating from computing system 104 may pass through a firewall prior to being received and processed at server 102. As used herein, “transmit” may include sending electronic data from one system component to another over a network connection. Additionally, as used herein, “data” may include encompassing information such as commands, queries, files, data for storage, and the like in digital or any other form. Server 102 may provide a suitable web site or other Internet-based graphical user interface elements which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, ORACLE, SYBASE, INFORMIX MySQL, InterBase, etc., may be used to provide an Active Data Object (ADO) compliant database management system.

Any of the communications, inputs, storage, databases or displays discussed herein may be facilitated through a web site having web pages. The term “web page” as it is used herein is not meant to limit the type of documents and applications that might be used to interact with the user. For example, a typical web site might include, in addition to standard HTML documents, various forms, Java applets, JavaScript, active server pages (ASP), common gateway interface scripts (CGI), extensible markup language (XML), dynamic HTML, cascading style sheets (CSS), helper applications, plug-ins, and the like. A server may include a web service that receives a request from a web server, the request including a URL (http://yahoo.com/stockquotes/ge) and an IP address (123.56.789.98). The web server retrieves the appropriate web pages and sends the data or applications for the web pages to the IP address. Web services are applications that are capable of interacting with other applications over a communications means, such as the Internet. Web services are typically based on standards or protocols such as XML, SOAP, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

Forms-packet system 100 also includes a user database 110, which stores information on users and the types of information accessible by each of the users; a client database 112, which stores information on clients of the users; and a transaction database 114, which stores user-client relationship information on the user or users corresponding to each client. For example, the user-client information may include a list of users authorized to handle business transactions on behalf of the client, information on the types of business transactions permitted to be handled by each listed user, information on the types of client information accessible by each listed user, etc. Additionally, user database 110 may include information on authorized delegates of the users. This enables a user to authorize his secretary or his administrative assistant, for example, to request forms packages on his behalf. Each authorized delegate may be associated with an authorization limit allowing him to, for example, request form packets and electronically save forms packets but not input information for the forms. As will be appreciated by those of ordinary skill in the relevant art(s), other types of authorization limits may be used and are within the scope of the present invention.

In one embodiment, server 102 accesses user database 110 using LDAP (Lightweight Directory Access Protocol) procedures. LDAP procedures also may be used by portal 116 to access user database 110 to determine topics relevant to a user. For example, based on profile information on a user obtained from user database 110, portal 116 may determine that the user is a member of Department A and therefore present the user with an initial screen page relevant to members of Department A.

In another embodiment, server 102 accesses data from client database 112 and transaction database 114 through a hub or message-queue manager 120, which manages data requests from server 102 as well as data retrieved from client database 112 and transaction database 114. Message-queue manager 120, which may be implemented in hardware, software, or a combination thereof, enables server 102 to communicate asynchronously with client database 112 and transaction database 114.

A forms database 122 is accessible by server 102. In one embodiment, forms database 122 stores a plurality of forms as separately addressable records, such that server 102 may identify a particular form for retrieval by using an address indicating where the form may be found. Forms stored in forms database 122 are updated as necessary, and any form no longer in use is deleted. This ensures that only current or up-to-date forms are retrieved for inclusion in forms packets.

In one embodiment, forms database 122 is external to forms-packet system 100. Server 102 accesses forms database 122 via the Web, and retrieves a desired form from forms database 122 by providing a URL (Uniform Resource Locator) corresponding to the desired form using, for example, HTTPS (HyperText Transfer Protocol—Secure) procedures.

A content manager 126, which may be implemented in hardware, software, or a combination thereof, may be used to manage requests for forms received from server 102. Content manager 126 retrieves requested forms from forms database 122 through, for example, HTTP, and provides the retrieved forms to server 102 using HTTPS procedures. In other embodiments, form requests and retrieval may be executed through any number of known API protocols and adapters such as, for example, Open Database Connectivity (ODBC), Java Database Connectivity (JDBC), and the like.

When multiple (i.e., two or more) forms are necessary for a business transaction, server 102 uses a forms “stitching” application to stitch together or combine the multiple forms into a forms packet. The forms “stitching” application may be employed as a commercial application, custom application, or a combination thereof. Server 102 then delivers the forms packet to computing system 104 via portal 116 for presentation to the user.

The forms in the forms packet are electronic forms, and the user may fill out the forms by using computing system 104 to input information to be inserted at information fields in the forms. Optionally, hardcopies of the forms may be printed and manually filled out. In one embodiment, the forms in the forms packet are pre-filled with information retrieved from user database 110 and client database 112 based on information provided by the user during execution of the forms program. For example, the forms may be pre-filled with user information such as name, title, contact information, etc., as well as client information, such as name, contact information, account number, etc.

Forms-packet system 100 further includes a drafts database 124, which stores drafts of forms packets assembled for users. Newly assembled forms packets as well as partially completed forms packets may be stored in drafts database 124 for later completion. Server 102 may use JDBC procedures, for example, to interact with drafts database 124.

In an embodiment of the present invention, the forms are XML documents. Information inserted at information fields in a form is formatted to be XML data, which enables the inputted information (i.e., XML data) to be saved separately from the form (i.e., XML document). A forms packet saved in drafts database 124 is saved as information identifying the forms contained in the forms packet. Therefore, when a request is received to retrieve the forms packet from drafts database 124, the forms belonging to the forms packet are retrieved anew from forms database 122. This ensures that the most current versions of the forms are provided to the user, and prevents forms that have been updated in the interim, between formation of the forms packet and completion of the forms in the forms packet, from being overlooked. Any XML data saved for the forms packet is inserted at the appropriate information fields in the forms, including any updated forms, prior to presenting the forms packet (i.e., the draft) to the user.

Although the above discussion may identify particular types of databases, a person of skill in the relevant art(s) will appreciate that the databases discussed herein may be of any type such as, for example, relational, hierarchical, graphical, object-oriented, and/or other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is, in one embodiment, the same or of the same type. However, data tables having similar, though not identical, data in the key fields may also be linked by using AGREP, for example. In accordance with one aspect of the invention, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the invention by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments of the invention, the data can be stored without regard to a common format. However, in one exemplary embodiment of the invention, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a standalone interaction device configured to create, update, delete or augment the data in accordance with the header or trailer. As such, in one embodiment, the header or trailer is not stored on the transaction device along with the associated issuer-owned data but instead the appropriate action may be taken by providing to the transaction instrument user at the standalone device, the appropriate option for the action to be taken. The invention may contemplate a data storage arrangement wherein the header or trailer, or header or trailer history, of the data is stored on the transaction instrument in relation to the appropriate data.

One skilled in the art will also appreciate that, for security reasons, any databases, systems, devices, servers or other components of the invention may consist of any combination thereof at a single location or at multiple locations, wherein each database or system includes any of various suitable security features, such as firewalls, access codes, encryption, decryption, compression, decompression, and/or the like.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The invention may be described herein in terms of functional block components, screen shots, optional selections and various processing steps. It should be appreciated that such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Similarly, the software elements of the invention may be implemented with any programming or scripting language such as C, C++, JAVA, COBOL, assembler, PERL, Visual Basic, SQL Stored Procedures, extensible markup language (XML), with the various algorithms being implemented with any combination of data structures, objects, processes, routines or other programming elements. Further, it should be noted that the invention may employ any number of conventional techniques for data transmission, signaling, data processing, network control, and the like. Still further, the invention could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

These software elements may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, web sites, web forms, prompts, etc. Practitioners will appreciate that the illustrated steps described herein may comprise in any number of configurations including the use of windows, web pages, web forms, popup windows, prompts and the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

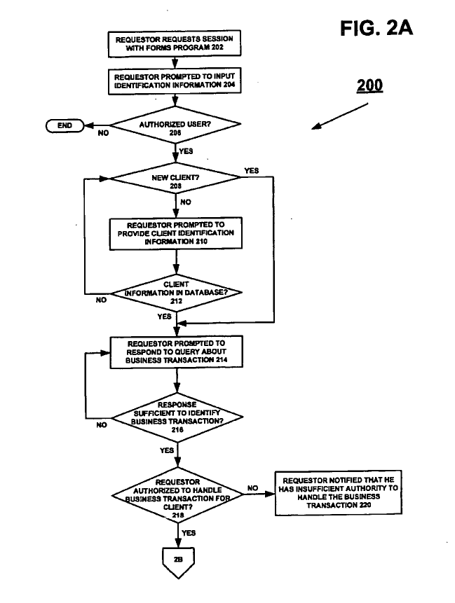

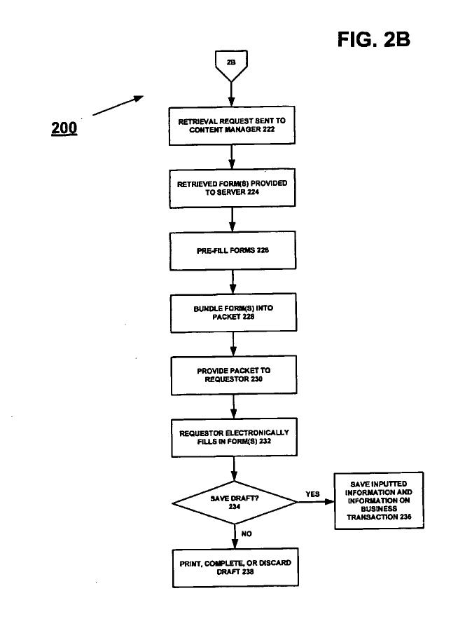

Referring to FIGS. 2A and 2B, a flowchart illustrating a forms-packet process 200, according to an embodiment of the present invention, is shown. In one embodiment, process 200 utilizes forms-packet system 100. As discussed above, optional security measures (e.g., firewall, SSO, etc.) may be implemented prior to and/or concurrently with communication with server 102.

Process 200 begins at step 202, at which a requestor uses computing system 104 to access portal 116 via communication network 106 to initiate a communication with server 102 to request a forms packet for a business transaction. Server 102 executes the forms program and presents interactive screen pages to the requestor via computing system 104. The sequence of screen pages presented to the requestor depends on responses provided by the requestor to queries in previous screen pages.

At step 204, the requestor is prompted to provide identification information, which is used by server 102 to determine whether the requestor is authorized to use the forms program, at step 206. For example, the determination may be based on information stored in user database 110. If server 102 cannot determine that the requestor is authorized to use the forms program, process 200 ends.

If the requestor is determined to be an authorized user, the requestor is prompted to indicate whether the client is a new client or an existing client, at step 208. If the requestor inputs information indicating that the client is a new client, process 200 proceeds to step 214. If the requestor inputs information indicating that the client is an existing client, the requestor is prompted to identify the client, at step 210. For example, the client may be identified by name, account number, or the like.

At step 212, server 102 confirms whether the client is an existing client based on information stored in client database 112. If the client cannot be confirmed to be an existing client, process 200 returns to step 208. If the client is confirmed to be an existing client, the requestor is prompted to respond to a query regarding the business transaction, at step 214. At step 216, server 102 determines whether a response to the query is sufficient to identify the business transaction and the necessary forms for the business transaction. If the response is insufficient, server 102 uses the response to determine the next screen page to present to the requestor. Process 200 loops back to step 214, and the next screen page prompts the requestor to respond to another query regarding the business transaction.

For example, the forms program may prompt the requestor to indicate a business-transaction category for the requested forms (e.g., retirement accounts, “529 Plan” accounts, brokerage accounts, annuities, and the like) by selecting an item from a list. If the requestor indicates that the business transaction relates to retirement accounts, the forms program determines which branch corresponds to the retirement-accounts category and executes the subroutine for that branch. Further branches that extend from that branch are directed to identifying details of the business transaction relating to retirement accounts. For example, a subsequent branch may be directed to determining whether the business transaction is to open a new IRA, roll over a 401K account to an existing IRA, redistribute assets in an existing IRA, and the like. If the requester indicates that a new IRA account is to be opened, a next subsequent branch may be directed to determining what type of IRA is to be opened (e.g., Roth IRA, traditional IRA, SEP IRA); a further subsequent branch may be directed to determining whether the IRA is a rollover from another retirement account; yet another subsequent branch may be directed to determining how the IRA will be funded (e.g., mutual funds, certificates of deposit, mutual funds, common stocks, etc.), and so on.

At step 218, if the response is determined to be sufficient, then all the forms needed for the identified business transaction are determined according to business-transaction information stored in storage unit 108. For example, the business-transaction information may include a list of business transactions stored in association with corresponding lists of all the forms necessary for the business transactions. Server 102 then uses information from client database 112 and transaction database 114 to determine whether the requester is authorized to handle the identified business transaction on behalf of the client.

If server 102 determines that the requestor is not authorized to handle the identified business transaction for the client, at step 220, the requester is notified that prior authorization is necessary for the identified business transaction for the client. This feature serves to prevent requestors from handling business transactions beyond their authority.

At step 222, if server 102 determines that the requestor is authorized to handle the identified business transaction on behalf of the client, individual retrieval requests identifying each form to be retrieved in parallel is sent to content manager 126. In another embodiment, a forms request may identify all requested forms to be retrieved sequentially. At step 224, content manager 126 retrieves all the identified forms and provides the forms to server 102. At step 226, server 102 pre-fills the forms with requestor information obtained from user database 110 and, if the client is an existing client, client information obtained from client database 112.

At step 228, server 102 assembles the forms into a forms packet. The forms packet is provided to the requestor as an electronic file via computing system 104, at step 230. The requestor may fill in the forms electronically via computer system 104 by inputting information at information fields in the forms, at step 232. Server 102 formats the inputted information as XML data. If the requestor wants to save a partially completed draft of the forms packet, at step 234, server 102 saves in drafts database 124 the XML data corresponding to the inputted information and saves information identifying the forms in the forms packet. In another embodiment, the requestor may choose to save a fully completed draft of the forms packet minus wet signatures in draft database 124. At step 238, the draft may be printed for manual completion, completed electronically, or discarded.

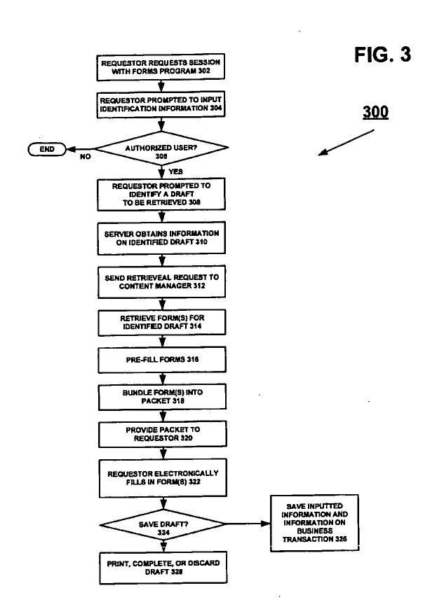

Referring to FIG. 3, a flowchart illustrating a retrieval process 300 for storing a draft of the forms packet, according to an embodiment of the present invention, is shown. In one embodiment, process 300 utilizes forms-packet system 100.

Process 300 begins at step 302, at which a requestor uses computing system 104 to access portal 116 via communication network 106 to initiate a communication with server 102 to request retrieval of a stored forms packet. Optional security measures may be implemented prior to and/or concurrently with communication with server 102. Server 102 executes the forms program and presents interactive screen pages to the requester via computing system 104.

At step 304, the requestor is prompted to provide identification information, which is used by server 102 to determine whether the requester is authorized to use the forms program, at step 306. If server 102 cannot determine that the requester is authorized to use the forms program, process 300 ends.

If the requester is determined to be an authorized user, the requester is prompted to provide information identifying a draft to be retrieved, at step 308. At step 310, server 102 obtains information regarding the draft from drafts database 124. The information includes information for assembling a forms packet for the business transaction corresponding to the draft, as well as any information previously inputted by the requestor and saved as part of the draft. At step 312, server 102 sends a retrieval request to content manager 126 to retrieve the forms for the forms packet.

At step 314, content manager 126 retrieves all the forms for the business transaction and provides the forms to server 102. At step 316, server 102 pre-fills the forms with information previously saved for the draft. At step 318, server 102 assembles the forms into a forms packet and provides the forms packet to the requestor as an electronic file via computing system 104, at step 320. The requester then may fill in the forms electronically via computer system 104, at step 322. If the requester wants to save a partially completed draft, at step 324, server 102 saves in drafts database 124 the XML data corresponding to the inputted information (i.e., previously as well as currently inputted information) and saves information identifying the forms in the forms packet. At step 238, the draft may be printed for manual completion, completed electronically, or discarded.

The present invention (i.e., forms-packet system 100, forms-packet process 200, retrieval process 300, or any part(s) or function(s) thereof) may be implemented using hardware, software, or a combination thereof, and may be implemented in one or more computer systems or other processing systems. Useful machines for performing some or all of the operations of the present invention include general-purpose digital computers or similar devices.

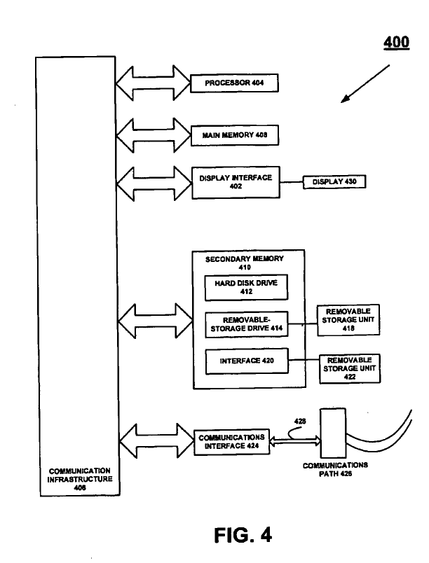

In fact, in one embodiment, the present invention is directed toward one or more computer systems equipped to carry out the functions described herein. An example of such a computer system 400 is shown in FIG. 4.

Computer system 400 includes at least one processor 404. Processor 404 is connected to a communication infrastructure 406 (e.g., a communications bus, a cross-over bar device, or a network). Although various software embodiments are described herein in terms of this exemplary computer system 400, after reading this description, it will become apparent to a person skilled in the relevant art(s) how to implement the invention using other computer systems and/or architectures.

Computer system 400 includes a display interface 402 that forwards graphics, text, and other data from communication infrastructure 406 (or from a frame buffer (not shown)) for display on a display unit 430.

Computer system 400 also includes a main memory 408, which in one embodiment is a random access memory (RAM), and may also include a secondary memory 410. Secondary memory 410 may include, for example, a hard disk drive 412 and/or a removable-storage drive 414 (e.g., a floppy disk drive, a magnetic tape drive, an optical disk drive, and the like). Removable-storage drive 414 reads from and/or writes to a removable storage unit 418 in a well-known manner. Removable storage unit 418 may be, for example, a floppy disk, a magnetic tape, an optical disk, and the like, which is written to and read by removable-storage drive 414. As will be appreciated, removable storage unit 418 includes a computer-usable storage medium having stored therein computer software and/or data.

In alternative embodiments, secondary memory 410 may include other similar devices for allowing computer programs or other instructions to be loaded into computer system 400. Such devices may include a removable storage unit 422 and an interface 420 (e.g., a program cartridge and a cartridge interface similar to those used with video game systems); a removable memory chip (e.g., an erasable programmable read-only memory (“EPROM”) or a programmable read-only memory (“PROM”)) and an associated memory socket; and other removable storage units 422 and interfaces 420 that allow software and data to be transferred from removable storage unit 422 to computer system 400.

Computer system 400 may also include a communications interface 424, which allows software and data to be transferred between computer system 400 and external devices (not shown). Examples of communications interface 424 may include a modem, a network interface (e.g., an Ethernet card), a communications port, a Personal Computer Memory Card International Association (“PCMCIA”) interface, and the like. Software and data transferred via communications interface 424 are in the form of signals 428, which may be electronic, electromagnetic, optical or another type of signal that is capable of being received by communications interface 424. Signals 428 are provided to communications interface 424 via a communications path 426 (e.g., a channel). Communications path 426 carries signals 428 and may be implemented using wire or cable, fiber optics, a telephone line, a cellular link, a radio-frequency (“RF”) link, or the like.

As used herein, the phrases “computer program medium” and “computer usable medium” may be used to generally refer to removable storage unit 418 used with removable-storage drive 414, a hard disk installed in hard disk drive 412, or and signals 428, for example. These computer program products provide software to computer system 400. The present invention may be implemented or embodied as one or more of such computer program products.

Computer programs (also referred to as computer control logic) are stored in main memory 408 and/or secondary memory 410. The computer programs may also be received via communications interface 424. Such computer programs, when executed, enable computer system 400 to perform the features of the present invention, as discussed herein. In particular, the computer programs, when executed, enable processor 404 to perform the features of the present invention. Accordingly, such computer programs represent controllers of computer system 400.

In one embodiment where the system is implemented using software, the software may be stored in a computer program product and loaded into computer system 400 using removable-storage drive 414, hard drive 412, or communications interface 424. The control logic (software), when executed by processor 404, causes processor 404 to perform the functions of the present invention as described herein.

In another embodiment, system is implemented primarily in hardware using, for example, hardware components such as application-specific integrated circuits (“ASICs”). Implementation of such a hardware arrangement so as to perform the functions described herein will be apparent to persons skilled in the relevant art(s).

In yet another embodiment, the system is implemented using a combination of both hardware and software.

The various embodiments described above have been presented by way of example and not limitation. It will be apparent to persons skilled in the relevant art(s) that various changes in form and detail can be made therein without departing from the spirit and scope of the present invention. Thus, the present invention should not be limited by any of the above-described exemplary embodiments, but should be defined only in accordance with the following claims and their equivalents. It is also to be understood that the steps and processes recited in the claims need not be performed in the order presented.

In addition, it should be understood that the attached drawings, which highlight the functionality and advantages of the present invention, are presented as illustrative examples. The architecture of the present invention is sufficiently flexible and configurable, such that it may be utilized (and navigated) in ways other than that shown in the drawings.

Further, the purpose of the appended Abstract is to enable the U.S. Patent and Trademark Office and the public generally, and especially scientists, engineers, and practitioners in the relevant art(s), who are not familiar with patent or legal terms and/or phraseology, to determine quickly from a cursory inspection the nature and essence of the technical subject matter disclosed herein. The Abstract is not intended to be limiting as to the scope of the present invention in any way.

What is claimed is:

1. A computer-implemented method for providing a form packet for a task, said method comprising the steps of:
storing rules in a first memory region accessible by a server;
for each of a plurality of tasks, storing an address corresponding to at a form associated with said task in a second memory region accessible by said server;
displaying, by a computer, a user interface that prompts a user to provide answers to questions, wherein said questions are determined according to said rules, and wherein a subsequent question of said questions is based on an answer to a previous question of said questions;
determining, by said server, a task being executed by said user, based on answers to said questions;
identifying, by said server, forms necessary for said determined task based on information stored in said second memory region;
obtaining and assembling said identified forms into a form packet; and
providing said form packet to said user via said computer.

2. The method of claim 1, further comprising the step of:
pre-filling fields in said forms based at least in part on the answers to said questions.

3. The method of claim 1, further comprising the step of:
said user interfacing with said computer to input information to complete, at least in part, said forms.

4. The method of claim 3, further comprising the step of:
storing, as a draft in a third memory region accessible by said server, information inputted by said user for said forms.

5. The method of claim 1, wherein said task is business transaction.

6. The method of claim 4, wherein said information inputted by the user for said forms is formatted as XML data.

7. A computer-implemented method for providing a form packet for a task, said method comprising the steps of:
for each of a plurality of tasks, storing a form necessary for executing said task in a first memory region accessible by said server;
storing information for a draft in a second memory region accessible by said server, said draft being associated with a task of said plurality of tasks;
receiving a request from a user for an identified draft, said request being transmitted from a computer;
retrieving, by said server, information stored in said second memory region for said identified draft;
determining, by said server, a task corresponding to said identified draft;
retrieving from said first memory region forms necessary for said determined task and assembling said forms into a form packet; and
providing said form packet to said user via said computer.

8. The method of claim 7, further comprising the step of:
inserting form data, included in said information stored for said identified draft, into fields in said forms.

9. A server for providing a form packet for a task, said server comprising:
a memory unit for storing rules; and
a controller programmed with:
a first module for causing a computer to display a user interface that prompts a user to provide answers to a sequence of questions, wherein said sequence of questions is determined according to said rules, and wherein a subsequent question of said sequence of questions is based on an answer to a previous question of said sequence of questions,
a second module for determining a task being executed by said user, based on said answers to said sequence of questions,
a third module for identifying forms necessary for said determined task,
a fourth module for obtaining said identified forms and assembling said identified forms into a form packet, and
a fifth module for providing said form packet to the user via said computer.

10. The server of claim 9, wherein said controller is further programmed with:
a sixth module for pre-filling fields in said forms based at least in part on said answers to said sequence of questions.

11. The server of claim 9, further comprising:
a memory unit for storing a draft of said forms, wherein said draft includes information inputted by said user for said forms.

12. The server of claim 9, wherein said task is business transaction.

13. A server according to claim 11, wherein said information inputted by said user for said forms is formatted as XML data.

14. A server for providing a form packet for a task, said server comprising:
a memory unit for storing information for a draft, said draft being associated with said task;
a controller programmed with:
a first module for receiving a request from a user for an identified draft, said request being transmitted from a computer;
a second module for retrieving from said memory unit information stored for said identified draft;
a third module for determining a task corresponding to said identified draft;
a fourth module for retrieving forms necessary for said determined task and assembling said forms into a form packet; and
a fifth module for providing said form packet to said user via said computer.

15. The server of claim 14, wherein said controller is further programmed with:
a sixth module for inserting form data, included in said information stored for said identified draft, into fields in said forms.

16. A computer program product comprising a computer-readable medium storing control logic for causing a computer system to provide a form packet for a task, said control logic comprising:
first computer-readable program code for causing a computer to display a user interface that prompts a user to provide answers to a sequence of questions, wherein said sequence of questions is determined according to rules stored in a server, and wherein a subsequent question of said sequence of questions is based on an answer to a previous question of said sequence of questions;
second computer-readable program code for causing said server to determine a task being executed by said user, based on said answers to said sequence of questions;
third computer-readable program code for causing said server to identify forms necessary for said determined task based on stored task information, wherein said stored task information includes an address corresponding to a form associated with said task;
fourth computer-readable program code for causing said server to obtain and assembling said identified forms into a form packet; and
fifth computer-readable program code for causing said server to provide said form packet to said user via said computer.

17. The computer program product of claim 16, wherein said control logic further comprises:
sixth computer-readable program code for causing said server to pre-fill fields in said forms based at least in part on said answers to said sequence of questions.

18. The computer program product of claim 17, wherein said control logic further comprises:
seventh computer-readable program code for causing said server to store as a draft information inputted by said user for said forms.

19. A computer program product comprising a computer-readable medium storing control logic for causing a computer system to provide a form packet for a task, said control logic comprising:
first computer-readable program code for causing a server to receive a request from a user for an identified draft, said request being transmitted from a computer;
second computer-readable program code for causing a server to retrieve information stored for said identified draft, wherein said information for said identified draft is stored in a draft memory unit that stores information for a draft, and wherein said draft is associated with a task of a plurality of tasks;
third computer-readable program code for causing said server to determine a task corresponding to said identified draft;
fourth computer-readable program code for causing said server to retrieve forms necessary for said determined task and to assemble said forms into a form packet, wherein said forms are retrieved from a forms memory unit that stores for each of the plurality of tasks a form necessary for executing said task; and
fifth computer-readable program code for causing said server to provide said form packet to said user via said computer.

20. The computer program product of claim 19, wherein said control logic further comprises:
sixth computer-readable program code for causing said server to insert form data, included in said information stored for said identified draft, into fields in said forms.
